(19) United States
(12) Patent Application Publication
(10) Pub. No.: US 2018/0039853 A1
(43) Pub. Date: Feb. 8, 2018

(54) Object Detection System and Object Detection Method

(71) Applicant: Mitsubishi Electric Research Laboratories, Inc., Cambridge, MA (US)

(72) Inventors: Ming-Yu Liu, Revere, MA (US); Oncel Tuzel, Cupertino, CA (US); Chenyi Chen, Princeton, NJ (US); Jianxiong Xiao, San Jose, CA (US)

(73) Assignee: Mitsubishi Electric Research Laboratories, Inc., Cambridge, MA (US)

(21) Appl. No.: 15/226,088

(22) Filed: Aug. 2, 2016

(51) Int. Cl. G06K 9/46; G06T 7/00; G06N 3/04; G06T 3/40

(52) U.S. Cl. CPC G06K 9/4671; G06T 3/40; G06T 7/0081; G06N 3/04; G06T 2207/10004; G06T 2207/20084

(57) ABSTRACT

A method for detecting an object in an image includes extracting a first feature vector from a first region of an image using a first subnetwork, determining a second region of the image by resizing the first region into a fixed ratio using a second subnetwork, wherein a size of the first region is smaller than a size of the second region, extracting a second feature vector from the second region of the image using the second subnetwork, classifying a class of the object using a third subnetwork on a basis of the first feature vector and the second feature vector, and determining the class of object in the first region according to a result of the classification, wherein the first subnetwork, the second subnetwork, and the third subnetwork form a neural network, wherein steps of the method are performed by a processor.

### FIELD OF THE INVENTION

This invention relates to neural networks, and more specifically to object detection systems and methods using a neural network.

### BACKGROUND OF THE INVENTION

Object detection is one of the most fundamental problems in computer vision. The goal of an object detection is to detect and localize all instances of pre-defined object classes in the form of bounding boxes with confidence values for given input images. An object detection problem can be converted to an object classification problem by a scanning window technique. However, the scanning window technique is inefficient because classification steps are performed for all potential image regions of various locations, scales, and aspect ratios.

The region-based convolution neural network (R-CNN) is used to perform a two-stage approach, in which a set of object proposals are generated as regions of interest (ROI) using a proposal generator and the existence of an object and the classes in the ROI are determined using a deep neural network. However, the detection accuracy of the R-CNN is insufficient for some case. Accordingly, another approach is required to further improve the object detection performance.

### SUMMARY OF THE INVENTION

Some embodiments of the invention are based on recognition that region-based convolution neural network (R-CNN) can use detect objects of different sizes. However, detecting small objects in an image and/or predicting the class label the small objects in the image is a challenging problem for scene understanding due to small number of pixels in the image representing the small object.

Some embodiments are based on realization that specific small objects are usually appearing in the specific contexts. For example, a mouse is usually place near a keyboard and a monitor. That context can be part of training and recognition to compensate for the small resolution of the small object. To that end, some embodiments extract feature vectors from different regions including the object. Those regions are of different size and provide different contextual information about the object. In some embodiments, the object is detected and/or classified based on combination of the feature vectors.

Various embodiments can be used to detect the object of different sizes. In one embodiment, the size of the object is governed by the number of pixels of the image forming the object. For example, a small object is represented by less number of pixels. To that end, one embodiment resizes the region surrounding the object by at least seven times to collect enough contextual information.

Accordingly, one embodiment discloses a non-transitory computer readable recoding medium storing thereon a program causing a computer to execute an object detection process. The object detection process includes extracting a first feature vector from a first region of an image using a first subnetwork; determining a second region of the image by resizing the first region, wherein a size of the first region differs from a size of the second region; extracting a second feature vector from the second region of the image using the first subnetwork; and detecting the object using a third subnetwork on a basis of the first feature vector and the second feature vector to produce a bounding box surrounding the object and a class of the object, wherein the first subnetwork, the second subnetwork, and the third subnetwork form a neural network.

Another embodiment discloses a method for detecting an object in an image. The method includes steps of extracting a first feature vector from a first region of an image using a first subnetwork; determining a second region of the image by resizing the first region; extracting a second feature vector from a second region of the image using a second subnetwork; classifying a class of the object using a third subnetwork on a basis of the first feature vector and the second feature vector; and determining the class of object in the first region according to a result of the classifying, wherein the first subnetwork, the second subnetwork, and the third subnetwork form a neural network, wherein steps of the method are performed by a processor.

Another embodiment discloses an objection detection system. The system includes a human machine interface; a storage device including neural networks; a memory; a network interface controller connectable with a network being outside the system; an imaging interface connectable with an imaging device; and a processor configured to connect to the human machine interface, the storage device, the memory, the network interface controller and the imaging interface, wherein the processor executes instructions for detecting an object in an image using the neural networks stored in the storage device, wherein the neural networks perform steps of: extracting a first feature vector from a first region of the image using a first subnetwork; determining a second region of the image by processing the first feature vector with a second subnetwork, wherein a size of the first region differs from a size of the second region; extracting a second feature vector from the second region of the image using the first subnetwork; and detecting the object using a third subnetwork on a basis of the first feature vector and the second feature vector to produce a bounding box surrounding the object and a class of the object, wherein the first subnetwork, the second subnetwork, and the third subnetwork form a neural network.

### BRIEF DESCRIPTION OF THE DRAWINGS

FIG. 1 is a block diagram of an object detection system for detecting small objects in an image according to some embodiments of the invention;

FIG. 2 shows a flowchart of processes for detecting a small object in an image;

FIG. 3 is a block diagram of a neural network used in a computer-implemented object detection method for detecting small objects in an image according to some embodiments;

FIG. 4A shows a procedure of resizing a target region image and a contest region image in an image;

FIG. 4B shows an example of a procedure applying a proposal box and a context box to a clock image in an image;

FIG. 4C shows a block diagram of a process for detecting a mouse image in an image;

FIG. 5 shows an example of statistics of small object categories;

FIG. 6 shows median bounding box sizes of objects per a category and the corresponding up-sampling ratios; and

FIG. 7 shows an example of average precision results performed by different networks.

### DETAILED DESCRIPTION OF THE PREFERRED EMBODIMENTS

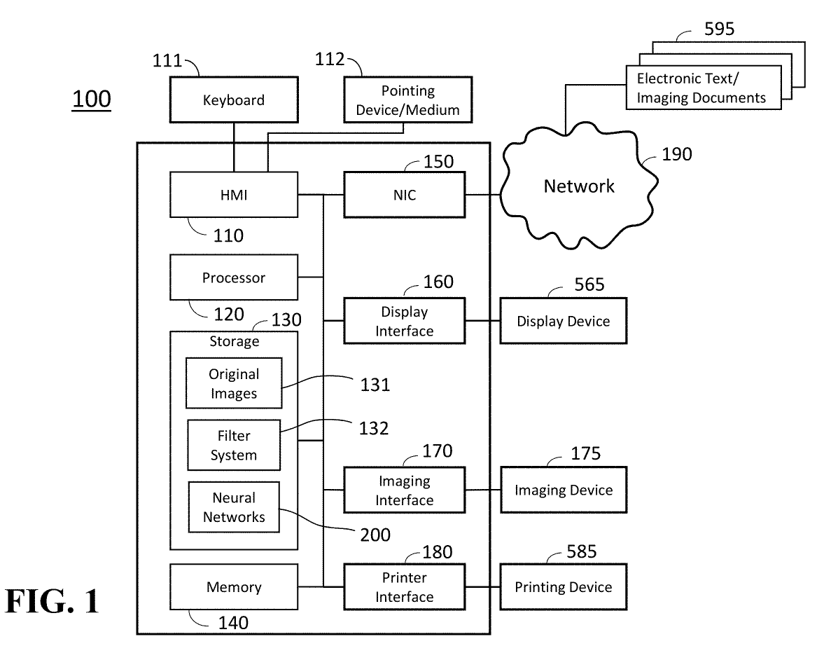

FIG. 1 shows a block diagram of an object detection system 100 according to some embodiments of the invention. The object detection system 100 includes a human machine interface (HMI) 110 connectable with a keyboard 111 and a pointing device/medium 112, a processor 120, a storage device 130, a memory 140, a network interface controller 150 (NIC) connectable with a network 190 including local area networks and internet network, a display interface 160, an imaging interface 170 connectable with an imaging device 175, a printer interface 180 connectable with a printing device 185. The object detection system 100 can receive electric text/imaging documents 595 via the network 190 connected to the NIC 150. The storage device 130 includes original images 131, a filter system module 132, and neural networks 200. The pointing device/medium 112 may include modules that read programs stored on a computer readable recording medium.

For detecting an object in an image, instructions may be transmitted to the object detection system 100 using the keyboard 111, the pointing device/medium 112 or via the network 190 connected to other computers (not shown in the figure). The object detection system 100 receives the instructions using the HMI 110 and executes the instructions for detecting an object in an image using the processor 120 using the neural networks 200 stored in the storage device 130. The processor 120 may be a plurality of processors including one or more than graphics processing units (GPUs). The filter system module 132 is operable to perform image processing to obtain predetermined formatted image from given images relevant to the instructions. The images processed by the filter system module 132 can be used by the neural networks 200 for detecting objects. An object detection process using the neural networks 200 is described below. In the following description, a glimpse region is referred to as a glimpse box, a bounding box, a glimpse bounding box or a bounding box region, which is placed on a target in an image to detect the feature of the target object in the image.

Some embodiments are based on recognition that a method for detecting an object in an image includes extracting a first feature vector from a first region of an image using a first subnetwork, determining a second region of the image by resizing the first region into a fixed ratio, wherein a size of the first region is smaller than a size of the second region, extracting a second feature vector from the second region of the image using a second subnetwork, and classifying a class of the object using a third subnetwork on a basis of the first feature vector and the second feature vector, and determining the class of object in the first region according to a result of the classifying, wherein the first subnetwork, the second subnetwork, and the third subnetwork form a neural network, wherein steps of the method are performed by a processor.

Some embodiments of the invention are based on recognition that detecting small objects in an image and/or predicting the class label the small objects in the image is a challenging problem for scene understanding due to small number of pixels in the image representing the small object. However, some specific small objects are usually appearing in the specific contexts. For example, a mouse is usually place near a keyboard and a monitor. That context can be part of training and recognition to compensate for the small resolution of the small object. To that end, some embodiments extract feature vectors from different regions including the object. Those regions are of different size and provide different contextual information about the object. In some embodiments, the object is detected and/or classified based on combination of the feature vectors.

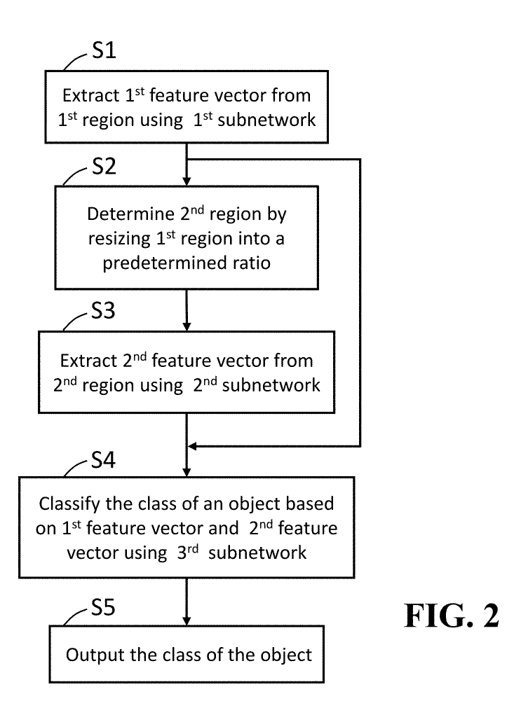

FIG. 2 shows a flowchart of processes for detecting a small object in an image. In step S1, a first feature vector is extracted from a first region in the image by using a first subnetwork. In step S2, a second region in the image is determined by resizing the first region with a predetermined ratio by used of a resize module. In step S3, a second feature vector is extracted from the second region by using a second subnetwork. In step S4, a third subnetwork classifies the object based on the first feature vector and second feature vector. The classification result of the object in the image is output by the third subnetwork in step S5. In this case, the first subnetwork, the second subnetwork, and the third subnetwork form a neural network, and the steps are performed by a processor. Further, the step of resizing the first region is performed such that each of the first region and the second region includes the object and a size of the first region is smaller than a size of the second region.

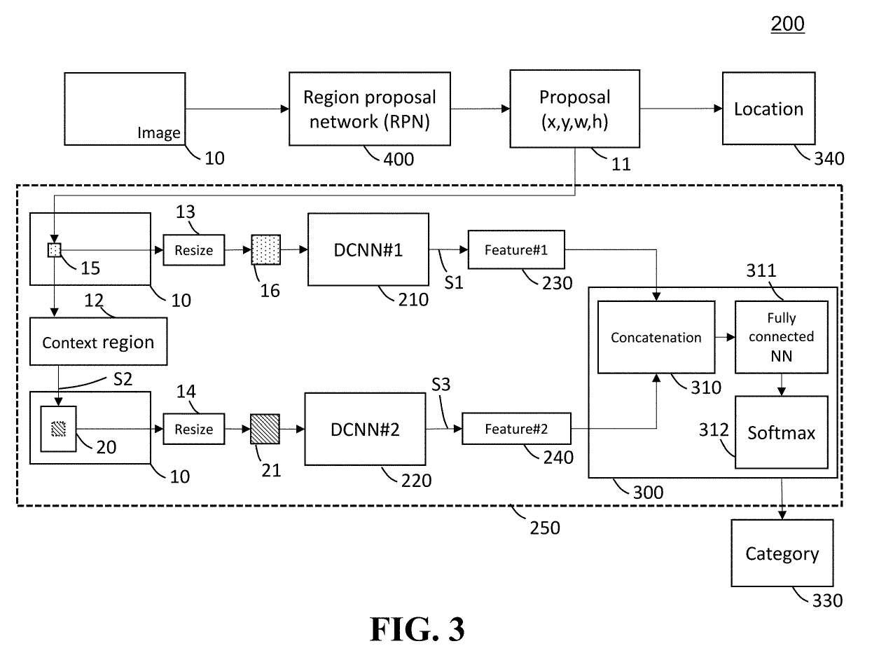

FIG. 3 shows a block diagram of an object detection method using the neural networks 200 according to some embodiments of the invention. The neural networks 200 includes a region proposal network (RPN) 400 and a neural network 250. The neural network 250 may be referred to as a ContexNet 250. The ContextNet 250 includes a context region module 12, a resize module 13, a resize module 14, a first deep convolutional neural network (DCNN) 210, a second deep convolutional neural network (DCNN) 220 and a third neural network 300. The third neural network 300 includes a concatenation module 310, a fully connected neural network 311 and a softmax function module 312. The first DCNN 210 may be referred to as a first subnetwork, the second DCNN 220 may be referred to as a second subnetwork and the third neural network 300 may be referred to as a third subnetwork. The first subnetwork and second subnetwork may have identical structure.

Upon instructions, when an image 10 is provided to the objet detection system 100, the region proposal network (RPN) 400 is applied to the image 10 to generate a proposal box 15 being placed on a region of a target object image in the image. The part of the image 10 encompassed by the proposal box 15 is referred to as a target region image. The target region image is resized to a resized object image 16 with a predetermined identical size and a predetermined resolution using a resize module 13, and the resized object image 16 is transmitted to the neural networks 200. Regarding the definition of small objects, a threshold size of small objects is predetermined to classify objects in the image into a small object category. The threshold size may be chosen according to the system design of object detection and used in the RPN 400 to generate the proposal box 15. The proposal box 15 also provides the location information 340 of the target object image in the image 10. For example, the threshold size may be determined based on predetermined physical sizes of objects in the image, pixel sizes of objects in the image or a ratio of an area of an object image to the whole area of the image. Successively, a context box 20 is obtained by enlarging the proposal box 15 by seven times in x and y directions (height and width dimensions) using the context region module 12. The context box 20 is placed on the proposal box 15 of the image 10 to surround the target region image, in which part of the image determined by placing the context box 20 is referred to as a context region image. In this case, the context region image corresponding to the context box 20 is resized, using the resize module 13, to a resized context image 21 having the predetermined size and transmitted to the ContexNet 250. The context region image may be obtained by magnifying the target region image by seven times or other values according to the data configurations used in the ContexNet 250. Accordingly, the target region image corresponding to the proposal box 15 and the context region image corresponding to the context box 20 are converted into the resized target image 16 and the resized context image 21 by using the resize module 13 and the resize module 14 before being transmitted to the ContexNet 250. In this case, the resized target image 16 and the resized context image 21 have the predetermined identical size. For example, the predetermined identical size may be 227×227 (224×224 for VGG16) patches (pixels). The predetermined identical size may be changed according to the data format used in the neural networks. Further, the predetermined identical size may be defined based on a predetermined pixel size or a predetermined physical dimension, and the aspect ratios of the target region image and the context region image may be maintained after being resized.

The ContexNet 250 receives the resized target image 16 and the resized context image 21 from the first DCNN 210 and the second DCNN 220, respectively. The first DCNN 210 in the ContexNet 250 extracts a first feature vector 230 from the resized target image 16, and transmits the first feature vector 230 to the concatenation module 310 of the third neural network 300. Further, the second DCNN 220 in the ContexNet 250 extracts a second feature vector 240 from the resized context image 21 and transmits the second feature vector 240 to the concatenation module 310 of the third neural network 300. The concatenation module 310 concatenates the first feature vector 230 and the second feature vector 240 and generates a concatenated feature. The concatenated feature is transmitted to the fully connected neural network (NN) 311, and the fully connected NN 311 generates a feature vector from the concatenated feature and transmits the concatenated feature vector to the softmax function module 312. The softmax function module 312 performs a classification of the target object image based on the concatenated feature vector from the fully connected NN 312 and outputs a classification result as a category output 330. As a result, the object detection of the target object image corresponding to the proposal box 15 is obtained based on the category output 330 and the location information 340.

Proposal Box and Context Box

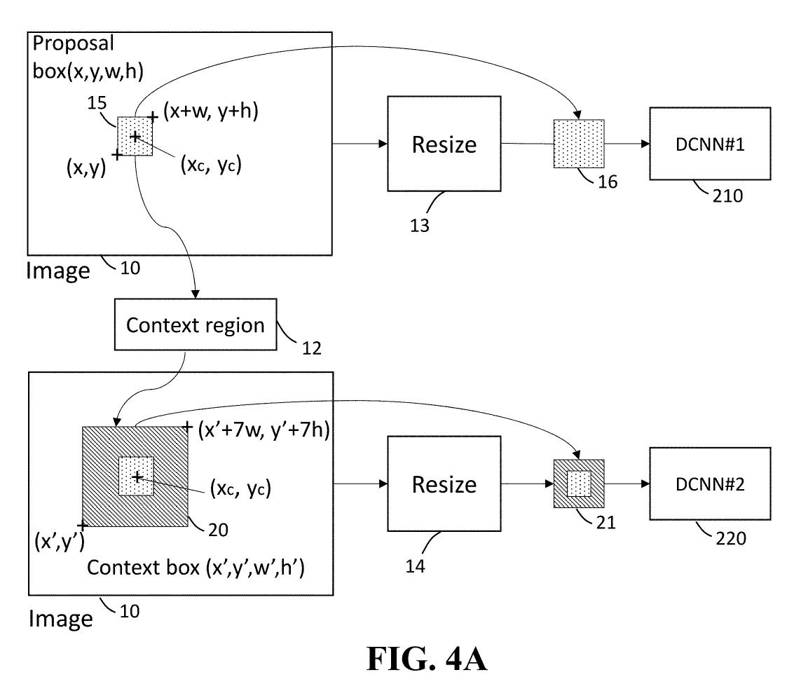

FIG. 4A shows a procedure of resizing a target region image and a contest region image in an image. When the proposal box 15 is applied to the image 10, the neural networks 200 crops the target region image corresponding to the proposal box 15 and resized the target region image to a resized target image 16, and the resized target image 16 is transmitted to the first DCNN 210. Further, the context region module 12 enlarges the proposal box 15 by seven times in both x and y directions to obtain the context box 20. The context region module 12 also places the context box 20 on the image 10 so that the context box 20 covers the target region image corresponding to the proposal box 15. The context region module 12 applies the context box 20 on the image 10 to define a context region image. Then the neural networks 200 crops the context region image corresponding to the context box 20 and resizes the context region image to a resized context image 21 having the predetermined size that is identical to that of the resized target image 16. The resized context image 21 is transmitted to the second DCNN 220, in which the second DCNN 220 and the first DCNN 210 have identical structure. This procedure improves detecting small objects because extracting features from greater areas in the image helps to incorporate context information resulting better discriminative operation. In another embodiment, the center of the context box 20 may be shifted from the center of the proposal box 15 by a predetermined distance according to a predetermined ratio between areas of the context box 20 and the proposal box 15.

In some embodiments, the context box 20 is set to be greater than the proposal box 15 so that the context box 20 encloses the proposal box 15. For example, each of side lines of the context box 20 may be seven times greater than or equal to that of the proposal box 15. In this case, the center of the proposal box 15 is arranged to be identical to that of the context box 20.

FIG. 4A also shows a generating process of the context box 20 from the proposal box 15. A vector of the context box 20 is obtained by converting a vector of the proposal box 15. The vector of the proposal box 15 is expressed by a position (x, y), a width w, and h a height of the proposal box 15. The position (x, y) indicates the position of one of corners of the proposal box 15 defined by x-y coordinate in the image 10. The vector of the proposal box 15 is expressed by (x, y, w, h), in which a left side lower corner is given by the position (x, y) and a diagonal position to the position (x, y) of the left side lower corner is obtained by (x+w, y+h). The center (x_{c}, y_{c}) of the proposal box 15 is expressed by a point (x+w/2, y+h/2). When the width w and height h of the proposal box 15 are enlarged by a factor c to provide the context box 20, the vector (x′, y′, w′, h′) of the context box 20 is expressed by (x_{c}−c·w/2, y_{c}−c·h/2, c·w, c·h). In FIG. 4A, the proposal box 15 and the context box 20 have the identical center (x_{c}, y_{c}). In another embodiment, the center of the context box 20 may be shifted from the center of the proposal box 15 according to predetermined amounts Δx and Δy. For example, the predetermined amounts 4x and Ay may be defined to satisfy the conditions of |Δx|≦(c−1)w/2 and |Δ|≦<(c−1)h/2 wherein c>1 so that the proposal box 15 is included in the context box 20 without protruding beyond the context box 20.

FIG. 4B shows an example of a procedure applying a proposal box and a context box to a clock image in an image 13, in which an enlarged clock image is indicated at the right upper corner of the image 13. It should be noted that the clock image is much smaller than the other objects, such as furniture, windows, a fireplace, etc. In FIG. 4B, a proposal box 17 is applied to part of the clock image as a target image in the image 13. Subsequently, the target image corresponding to the proposal box 17 is enlarged into a resized target image 16 and transmitted to the first DCNN 210 via the resize module 13. Further, the neural network 200 provides a context box 22 based on the proposal box 17 and applied the context box 22 to the clock image, in which the context box 22 is arranged to fully surround the proposal box 17 with a predetermined area as shown in the figure. An image region corresponding to the context box 22 is cropped as a context image from the image 13 and the resize module 14 resizes the context image into a resized context image 21. The resized context image 21 is transmitted to the second DCNN 220. In this case, the context image encloses the target image as seen in the figure. This procedure makes it possible for the neural network 200 to obtain the crucial information of a small object in the image, resulting higher accuracy for small object classifications.

FIG. 4C shows a block diagram of a process for detecting a mouse image in an image. When an image 30 is provided, the region proposal network 400 provides a proposal box 31 corresponding to a target object image showing a back side of a mouse on a desk and provides a context box 32 surrounding the proposal box 31. After being resized by the resize module 13 (not shown), a resized target image of the target object image is transmitted to the first DCNN 210 (indicated as convolutional layers). The first DCNN 210 extracts a first feature vector of the target object image from the resized target image and transmits the first feature vector to the concatenation module 310. Further, the context box 32 is applied to the image 30 to determine a context region image that encloses the target object image. After being resized by the resize module 14 (not shown), a resized context image of the context region image is transmitted to the second DCNN 220 (indicated as convolutional layers). The second DCNN 220 extracts a second feature vector of the context region image from the resized context image and transmits the second feature vector to the concatenation module 310. After obtaining the first feature vector and the second feature vector, the concatenation module 310 concatenates the first and second feature vectors and generates a concatenated feature. The concatenated feature is transmitted to the fully connected NN 311 (indicated as fully connected layers). The fully connected NN 311 generates and transmits a feature vector to the softmax function module 312. The softmax function module 312 performs a classification of the target object image based on the feature vector from the fully connected NN 312 and outputs a classification result. The classification result indicates that a category of the target object image is a “mouse” as shown in the figure.

Small Object Dataset

As a small proposal box corresponding to a small object in an image causes a low dimensional feature vector, the size of a proposal box is chosen to obtain appropriate sized vectors that accommodate the context information of the proposal box in the object detection system 100.

In some embodiments, a dataset for detecting small objects may be constructed by selecting predetermined small objects from conventional datasets, such as the SUN and Microsoft COCO datasets. For example, a subset of images of small objects are selected from the conventional datasets, and the ground truth bounding box locations in the conventional datasets are used to prune out big object instances from the conventional datasets and compose a small object dataset that purely contains small objects with small bounding boxes. The small object dataset may be constructed by computing the statistics of small objects.

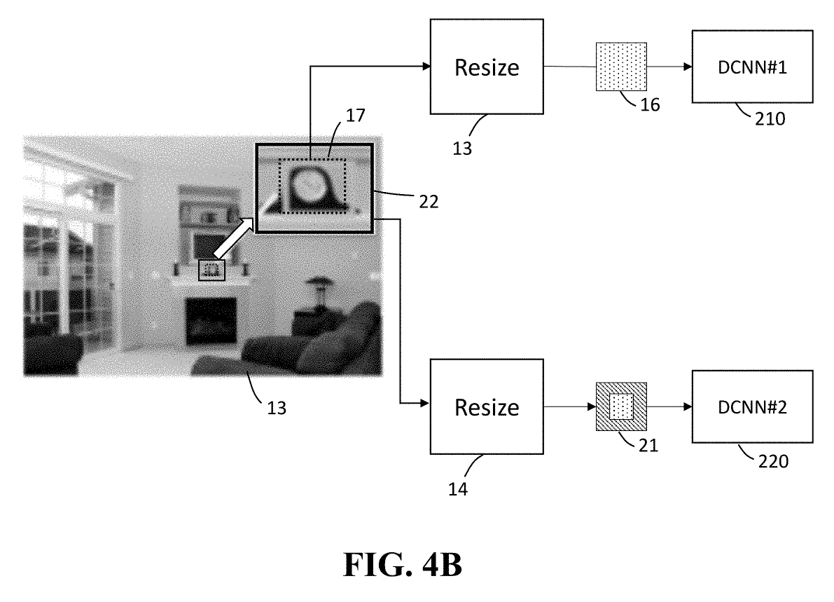

FIG. 5 shows an example of statistics of small object categories. Ten example categories are listed in the figure. For example, it is seen that there are 2137 instances in 1739 images with respect to “mouse” category. Other categories such as “telephone”, “switch”, “outlet”, “clock”, “toilet paper”, “tissue box”, “faucet”, “plate”, and “jar” are also listed in the figure. FIG. 5 also shows the median relative area with respect to each category, in which the median relative area corresponds to the ratio of a bounding box area over the entire image area of object instances in the same category. The median relative area ranges between 0.08% and 0.58%. The relative areas correspond to pixel areas between 16×16 pixels² and 42×42 pixels² in VGA image. Thus, the small object dataset constructed according to the embodiment is customized for small objects. The sizes of small bounding boxes may be determined based on the small object dataset described above. On the other hand, a median of relative areas of object categories in a conventional dataset, such as the PASCAL VOC dataset, ranges between 1.38% and 46.40%. Accordingly, the boundary boxes provided by the small object dataset according to some embodiments of the invention can provide more accurate bounding boxes for small objects than the bounding boxes provided by the conventional dataset, because the conventional dataset provides much wider bounding box areas with respect to object categories that are not customized for small objects.

In constructing the small object dataset, the predetermined small objects may be determined by categorizing instances having physical dimensions smaller than a predetermined size. For example, the predetermined size may be 30 centimeters. In another example, the predetermined size may be 50 centimeters according to the object detection system design.

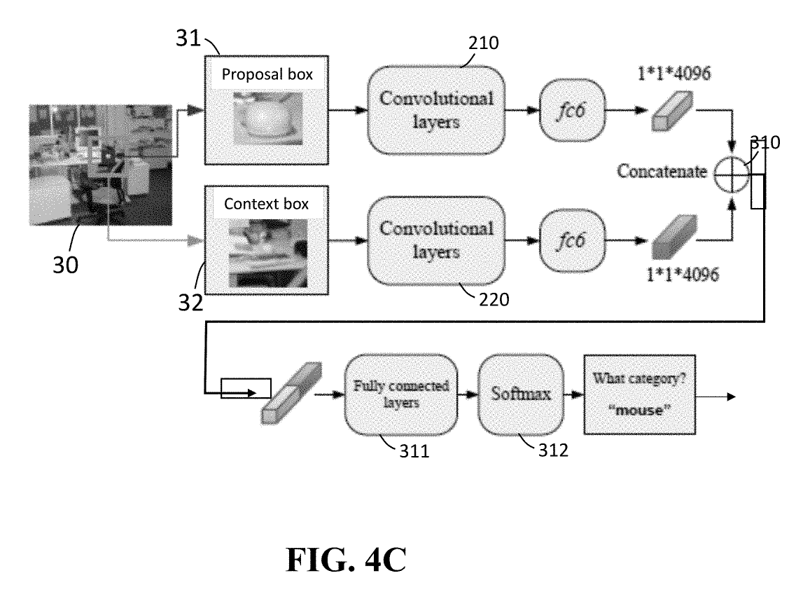

FIG. 6 shows median bounding box sizes of objects per a category and the corresponding up-sampling ratios. In the embodiment, the up-sampling ratio is chosen to be 6 to 7 to match an input size (227×227 in this case) of the deep convolutional neural network.

Configuration of Networks

In some embodiments, the first DCNN 210 and second DCNN 220 are designed to have identical structure, and each of the first DCNN 210 and the second DCNN 220 includes a few convolutional layers. In training process, the first DCNN 210 and the second DCNN 220 are initialized using the ImageNet pre- trained model. While the training process continues, the first DCNN 210 and the second DCNN 220 separately evolve weights of the networks and do not share the weights.

The first feature vector 230 and the second feature vector 240 are derived from the first six layers of the AlexNet or from the first six layers of the VGG16. The target object image corresponding to the proposal box 15 and the context region image corresponding to the context box 20 are resized to 227×227 for AlexNet and 224×224 for VGG16 image patches. The first DCNN 210 and the second DCNN 220 respectively output 4096-dimensional feature vectors, and the 4096-dimensional feature vectors are transmitted to the third neural network 300 that includes the concatenation module 310, the fully connected NN 311 having two fully connected layers and the softmax function module 312. After receiving a concatenated feature from the first DCNN 210 and the second DCNN 220, the third neural network 300 outputs a predicted object category label using the softmax function module 312 with respect the target object image based on a concatenated feature vector generated by the concatenation module 310. In this case, the pre-trained weights are not used for a predetermined number of last layers in the fully connected NN 311. Instead the convolution layers are used.

The proposal box 15 can be generated by a Deformable Part Model (DPM) module based on the Histogram of Oriented Gradient (HOG) features and latent support vector module. In this case, the DPM module is designed to detect a category-specific objects, and the sizes of a root and part template of the DPM module are adjusted to accommodate a small object size, and then the DMP module is trained for predetermined different classes.

The proposal box 15 can be generated by a region proposal network (RPN) 400. The proposal box 15 generated by the RPN 400 is designed to have a predetermined number of pixels. The number of pixels may be 16², 40² or 100² pixel² according to the configuration design of the object detection system 100. In another example, the number of pixels may be greater than 100² pixel² when the category of small objects in the datasets of an object detection system is defined to be greater than 100² pixel². For example, the conv4_3 layer of the VGG network is used for feature maps associated with small anchor boxes, in which the receptive field of the conv4_3 layer is 92×92 pixels².

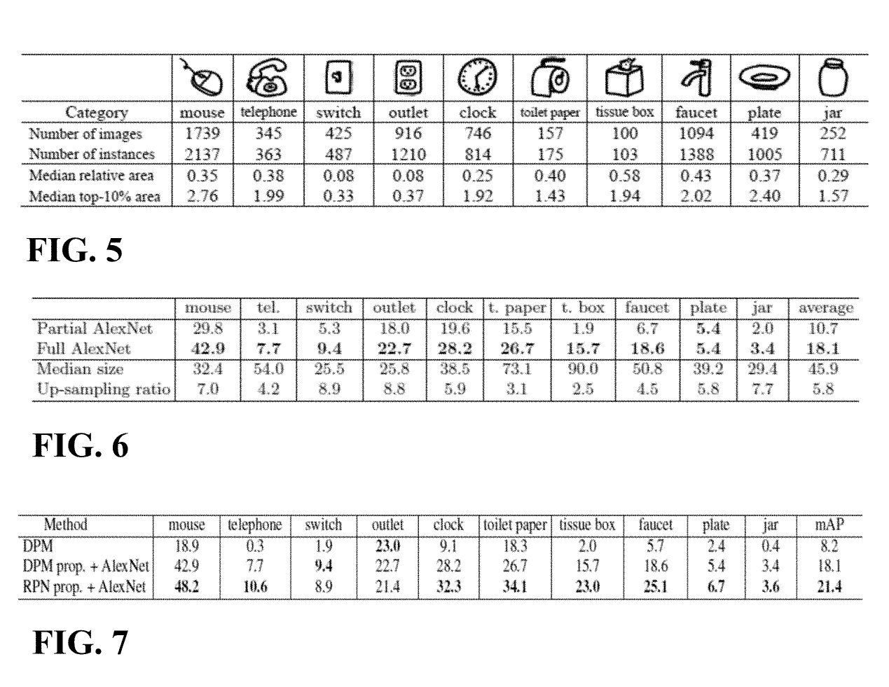

FIG. 7 shows an example of average precision results performed by different networks. In this example, the ContextNet is referred to as AlexNet. The second row (DPM prop.+AlexNet) is obtained by using DPM proposals, in which training and testing are performed by 500 per an image per a category. The third row (RPN prop.+AlexNet) is obtained by using RPN according to some embodiments, in which the training is performed by 2000 par an image and testing is performed by 500 per an image. The results show that PRN proposals with AlexNet training provide better performance than the others.

In classifying an object, a correct determination is made if an overlap ratio between the object box and the ground truth bounding box is greater than 0.5, in which the overlap ratio is measured by the Intersection over Union (IoU) measuring module.

In another embodiment, the overlap ration may be changed according to a predetermined detection accuracy designed in the object detection system 100.

Although several preferred embodiments have been shown and described, it would be apparent to those skilled in the art that many changes and modifications may be made thereunto without the departing from the scope of the invention, which is defined by the following claims and their equivalents.

We claim:

1. A method for detecting an object in an image, comprising:
extracting a first feature vector from a first region of an image using a first subnetwork;
determining a second region of the image by resizing the first region;
extracting a second feature vector from a second region of the image using a second subnetwork;
classifying a class of the object using a third subnetwork on a basis of the first feature vector and the second feature vector; and
determining the class of object in the first region according to a result of the classifying,
wherein the first subnetwork, the second subnetwork, and the third subnetwork form a neural network, wherein steps of the method are performed by a processor.

2. The method of claim 1, wherein the resizing the first region is performed such that each of the first region and the second region includes the object, and wherein a size of the first region is smaller than a size of the second region.

3. The method of claim 1, wherein the resizing is performed according to a fixed ratio, and the second subnetwork is a deep convolutional neural network.

4. The method of claim 1, wherein at least one of the first subnetwork and second subnetwork is a deep convolutional neural network, and wherein the third subnetwork is a fully-connected neural network.

5. The method of claim 4, wherein the third subnetwork performs a feature vector concatenation operation of the first feature vector and the second feature vector.

6. The method of claim 1, further comprising:
rendering the detected object and the class of the object on a display device or transmitting the detected object and the class of the object.

7. The method of claim 1, wherein the first region is obtained by a region proposal network.

8. The method of claim 7, wherein the region proposal network is a convolutional neural network.

9. The method of claim 1, wherein a width of the second region is seven times larger than a width of the first region.

10. The method of claim 1, wherein a height of the second region is seven times larger than a height of the first region.

11. The method of claim 1, wherein a width of the second region is three times larger than a width of the first region.

12. The method of claim 1, wherein a height of the second region is three times larger than a height of the first region.

13. The method of claim 1, wherein a center of the second region corresponds to a center of the first region.

14. The method of claim 1, wherein the first region is resized to a first pre-determined size before the first region is input to the first subnetwork.

15. The method of claim 1, wherein the second region is resized to a second pre-determined size before the second region is input to the second subnetwork.

16. The method of claim 1, wherein the first region is obtained by using a deformable part model object detector.

17. A non-transitory computer readable recoding medium storing thereon a program causing a computer to execute an object detection process, the object detection process comprising:
extracting a first feature vector from a first region of an image using a first subnetwork;
determining a second region of the image by resizing the first region, wherein a size of the first region differs from a size of the second region;
extracting a second feature vector from the second region of the image using the first subnetwork; and
detecting the object using a third subnetwork on a basis of the first feature vector and the second feature vector to produce a bounding box surrounding the object and a class of the object, wherein the first subnetwork, the second subnetwork, and the third subnetwork form a neural network.

18. An objection detection system comprising:
a human machine interface;
a storage device including neural networks;
a memory;
a network interface controller connectable with a network being outside the system;
an imaging interface connectable with an imaging device; and
a processor configured to connect to the human machine interface, the storage device, the memory, the network interface controller and the imaging interface,
wherein the processor executes instructions for detecting an object in an image using the neural networks stored in the storage device, wherein the neural networks perform steps of:
extracting a first feature vector from a first region of the image using a first subnetwork;
determining a second region of the image by processing the first feature vector with a second subnetwork, wherein a size of the first region differs from a size of the second region;
extracting a second feature vector from the second region of the image using the first subnetwork; and
detecting the object using a third subnetwork on a basis of the first feature vector and the second feature vector to produce a bounding box surrounding the object and a class of the object, wherein the first subnetwork, the second subnetwork, and the third subnetwork form a neural network.
